(19) United States
(12) Patent Application Publication
(10) Pub. No.: US 2014/0239235 A1
(43) Pub. Date: Aug. 28, 2014

(54) AUTO-THERMAL EVAPORATIVE LIQUID-PHASE SYNTHESIS METHOD FOR CATHODE MATERIAL FOR BATTERY

(71) Applicants: Lingyong Kong, Shenzhen (CN); Xuewen JI, Shenzhen (CN); Yunshi Wang, Shenzhen (CN)

(72) Inventors: Lingyong Kong, Shenzhen (CN); Xuewen JI, Shenzhen (CN); Yunshi Wang, Shenzhen (CN)

(73) Assignee: SHENZHEN DYNANONIC CO., LTD.

(21) Appl. No.: 14/352,165

(22) PCT Filed: Jul. 20, 2012
(86) PCT No.: PCT/CN2012/078976

§ 371 Date: Apr. 16, 2014

(51) Int. Cl. H01M 4/1397; H01M 4/04; C01B 25/45

(52) U.S. Cl. CPC H01M 4/1397; C01B 25/45; H01M 4/04; H01M 2220/30
USPC 252/506; 423/306

(57) ABSTRACT

Provided is an auto-thermal evaporative liquid-phase synthesis method for cathode material for battery, comprising the following steps: (1) Adding a synthetic raw material of cathode material into a solvent to obtain a mixture A, the synthetic raw material of the cathode material containing lithium source, adding an accelerant into the mixture A, which makes the mixture A achieve a strong auto-thermal reaction to release heat to evaporate the solvent, and obtaining a solid precursor of the cathode material; (2) Drying the precursor, sintering in an atmosphere furnace and obtaining the cathode material. The method is simple in process, low in energy consumption, requirements for equipment and cost, and is applicable to industrial mass production and application. The cathode material obtained through the method is stability in batch, easy to process, low in internal resistance and high in capacity and has an excellent charging and discharging performance.

### FIELD OF THE INVENTION

The present invention relates to a preparation method for electrode material for battery, especially to an auto-thermal evaporative liquid-phase synthesis method for cathode material for battery.

### BACKGROUND OF THE INVENTION

Since the first piece of commercialized battery was born in 1990, with the development of science and technology, all kinds of battery have been widely used in all kinds of electronic products and mobile devices. Therefore, the synthesis method for electrode material for battery, which is efficient and fast, energy-saving, easy for large-scale production becomes the research hot spot.

At present, taking lithium iron phosphate (LiFePO₄) material as an example, the synthesis methods for large-scale production mainly include high temperature solid state method and hydrothermal synthesis method, etc. High temperature solid state method is to mix raw materials with a certain stoichiometric ratio, and heat at a certain temperature to make solid predecomposition, grind uniformly the solid mixture obtained after decomposition, and then sinter at high temperature. High temperature solid state method has the problems of high energy consumption and high requirements for equipment, and the particle size of the product is not easy to control, uneven distribution, the morphology of the product is irregular. Hydrothermal synthesis method is to synthesize FePO₄.2H₂O by Na₂HPO₄ and FeCL₃, then synthesize LiFePO₄ by FePO₄.2H₂O and CH₃COOLi through hydrothermal synthesis method. Compared with high temperature solid state method, the synthesis temperature of the hydrothennal synthesis is lower, about 150° C.-200° C., and the response time is only about ⅕ of the solid phase reaction, however, in this kind of synthetic method, it is easy to appear Fe dislocation phenomenon when forming olivine structure, as to affect the electrochemical properties of the product, and hydrothermal synthesis method need the equipment which is resistant to high temperature and high pressure, so the industrial production is more difficult.

### SUMMARY OF THE INVENTION

To solve the above problems, the present invention is aiming at providing an auto-thermal evaporative liquid-phase synthesis method for cathode material for battery. The method is simple in process, low in energy consumption, low in requirements for equipment, and low in cost and is applicable to industrial mass production and application. The cathode material for a battery obtained through the method is stability in batch, easy to process, low in internal resistance and high in capacity and has an excellent charging and discharging performance.

The auto-thermal evaporative liquid-phase synthesis method for cathode material for battery provided in the present invention, comprising the following steps:

(1) Adding synthetic raw materials of cathode material into a solvent to obtain a mixture A, the synthetic raw materials of the cathode material contain lithium source, adding an accelerant into the mixture A, which makes the mixture A achieve a strong auto-thermal reaction to release heat to evaporate the solvent naturally, and obtaining a solid precursor of the cathode material;

(2) Drying the precursor of the cathode material, sintering in an atmosphere furnace and obtaining the cathode material.

The step (1) is the process that adding an accelerant to make the mixture A formed by synthetic raw material of the cathode material achieves an auto-thermal reaction, and obtaining a solid precursor of the cathode material.

Preferably, in step (1), the accelerant is one of or any their combination of reducing alcohol, reducing organic compounds containing aldehyde group and organic peracid. Preferably, the accelerant is one of or any their combination of ethylene glycol, formic acid, ethyl formate, glucose, acetaldehyde, formaldehyde and peroxyacetic acid.

Under normal temperature and pressure, the accelerant added into the mixture A makes the mixture A achieve an auto-thermal reaction to release heat, the heat leads to the solvent in the reaction solution is evaporated quickly. When the solvent is evaporated completely, the liquid changes into solid cathode material, and the reaction terminates automatically for lack of water, and obtain the solid precursor of the cathode material. The process doesn't need the external energy, and is low in requirements for equipment, so which saves the energy.

Preferably, in step (1), the amount of the accelerant is 10-90% of the mass of the cathode material.

The amount of the accelerant depends on the pre-preparative mass of cathode material, namely to calculate the theory amount of the accelerant should be added according to the pre-preparative mass of cathode material. In order to avoid the waste of the accelerant, the amount of the accelerant is controlled in 10-90% of the mass of cathode material.

Step (1) can proceed at normal temperature and pressure, and reaction will be accelerated under the condition of high temperature or low pressure.

Preferably, the step (1) also comprising that, adding conductive carbon dispersion liquid B which is dispersed by additive into the mixture A before adding the accelerant.

Preferably, the conductive carbon is one or more of carbon nanotube, conductive carbon black and acetylene black. More preferably, the conductive carbon is carbon nanotube.

Preferably, carbon nanotube is single-walled carbon nanotube, double-walled carbon nanotube and multi-walled carbon nanotube.

Preferably, additive is one or more of polyvinyl alcohol, polyethylene glycol, polyethylene oxide, sodium polystyrene sulfonate, polyoxyethylene nonylphenyl ether, cetyl trimethyl ammonium chloride, cetyl trimethyl ammonium bromide, octadecyl trimethyl ammonium chloride and octadecyl trimethyl ammonium bromide.

Preferably, the conductive carbon mix with additive in terms of the weight ratio of 1:0.01-10.

Preferably, the weight percentage of the conductive carbon in the cathode material is 0.1-10%.

Carbon nanotube has excellent thermal and electrical conductivity. In the step (1), adding conductive carbon dispersion liquid B which is dispersed by additive into the mixture A, and obtaining mixture A containing conductive carbon dispersion B, as the auto-thermal evaporation of the solution in the step (1), carbon nanotubes were uniformly dispersed in the precursor of cathode material, then obtaining cathode material coated with carbon nanotubes through the sintering process in step (2). The volume resistivity of the cathode material is lower after coated by carbon nanotubes, and the cycle life and high rate charging and discharging performance of the battery made by the cathode material have improved effectively.

Preferably, in step (1), the lithium source including one or more of lithium dihydrogen phosphate, lithium hydroxide, lithium carbonate, lithium nitrate and lithium chloride.

Preferably, in step (1), the solvent is one or more of water, methanol, ethanol, propanol, isopropanol, n-butyl alcohol, isobutyl alcohol, n-amyl alcohol, hexyl alcohol, heptanol, acetone, butanone, butanedione, pentanone, cyclopentanone, hexanone, cyclohexanone and cycloheptanone.

Preferably, in step (1), the cathode material is lithium cobalt oxide, lithium nickel oxide, lithium manganese oxide, lithium ferrous metasilicate, lithium manganese phosphate, lithium ferric manganese phosphate or lithium iron phosphate

Taking lithium iron phosphate as an example:

Preferably, in step (1), synthetic raw materials of the cathode material are soluble lithium source, iron source, phosphorus source, doping elements source and complexing agent.

Preferably, the iron source including one or more of iron phosphate, ferric nitrate, ferrous oxalate, ferric oxide, ferric sulfate and ferrous sulfate.

Preferably, the phosphorus source including one or more of phosphoric acid, ammonium hydrogen phosphate, ammonium dihydrogen phosphate, iron phosphate and lithium dihydrogen phosphate.

Preferably, the doping elements source is one or more of their compounds of boron, cadmium, copper, magnesium, aluminum, zinc, manganese, titanium, zirconium, niobium, chromium and rare earth compounds.

Preferably, the complexing agent is one or more of citric acid, malic acid, tartaric acid, oxalic acid, salicylic acid, succinic acid, glycine. EDTA and sucrose.

Preferably, in step (1), the mixture A was prepared by the following method: mixing the soluble lithium source, iron source, phosphorus source and doping elements source in molar ratio, then mixing with complexing agent in terms of the weight ratio of 1:0.1-10 and dissolving in the solvent to form the mixture A.

Preferably, in the mixture A, the lithium source, iron source, phosphorus source and doping elements source were mixed in terms of the molar ratio of Li:Fe:P: doping element that 0.95-1:0.95-1:0.95-1:0-0.05.

The step (2) is the process that drying and sintering the precursor of the cathode material and obtaining the cathode material.

Preferably, in step (2), drying temperature is in the range of 80-180° C., and drying time is in the range of 10-24 hours.

Preferably, in step (2), the gas in the atmosphere furnace is one or more of hydrogen, nitrogen and argon.

Preferably, in step (2), sintering temperature is in the range of 500-900° C., and sintering time is in the range of 3-16 hours.

The auto-thermal evaporative liquid-phase synthesis method for cathode material for a battery provided in the present invention has the following beneficial effects.

(1) The method has synthesized cathode material for battery through making use of accelerant, which makes the reactant achieve an auto-thermal reaction to release heat to quickly evaporate the solvent, under normal temperature and pressure, so as to solve the problems of high energy consumption, uneven distribution of elements, high requirements for equipment which bring about by the solid state method; Simultaneously, solve the deficiency of high-pressure equipment is required in hydrothermal synthesis method;

(2) The method is simple in process, non-pollution, not need external energy, low in energy consumption, and low in cost and is applicable to industrial mass production and application.

(3) The cathode material for a battery obtained through the method is stability in batch, easy to process, low in internal resistance and high in capacity and has an excellent charging and discharging performance.

Therefore, the auto-thermal evaporative liquid-phase synthesis method for cathode material for a battery provided in the present invention has extensive application prospect.

### BRIEF DESCRIPTION OF THE DRAWINGS

FIG. 1 shows the SEM image of lithium iron phosphate prepared in the example 1 of the present invention;

FIG. 2 shows the SEM image of lithium manganese phosphate prepared in the example 9 of the present invention;

FIG. 3 shows the SEM image of lithium ferric manganese phosphate prepared in the example 15 of the present invention.

### DETAILED DESCRIPTION OF ILLUSTRATED EMBODIMENTS

The following description will depict preferred embodiments of the present invention in more detail. It should be noted that, those skilled in the art will recognize that the invention can be practiced with modification within the spirit of the principle, and the modification is also within the scope of protection of the present invention.

### Example 1

Mixing 35.15 g of lithium carbonate (formula is Li₂CO₃, 0.475 mol), 404 g of ferric nitrate (formula is Fe(NO₃)₃.9H₂O, 1 mol). 115 g of ammonium dihydrogen phosphate (formula is NH₄H₂PO₄, 1 mol) and 18.75 g of aluminum nitrate (formula is Al(NO₃)₃.9H₂O, 0.05 mol), then mixing with 57.3 g of malic acid and dissolving in the water to obtain mixture A. Mixing 15.9 g of multi-walled carbon nanotubes and 48 g of polyoxyethylene, and dispersing in water by ultrasonic to form conductive carbon dispersion B. Mixing the mixture A and the conductive carbon dispersion B, and obtaining mixture A containing conductive carbon dispersion B. Adding 15.9 g of formic acid into the mixture A containing conductive carbon dispersion B, the accelerant formic acid makes the mixture A achieve a chemical reaction to release heat, as to the moisture in the reaction solution is dehydrated by the heat naturally, and obtaining a solid precursor of lithium iron phosphate. Drying the obtained solid precursor at 80° C. for 24 hours, and sintering in the nitrogen atmosphere furnace at 500° C. for 16 hours, then obtaining the lithium iron phosphate material.

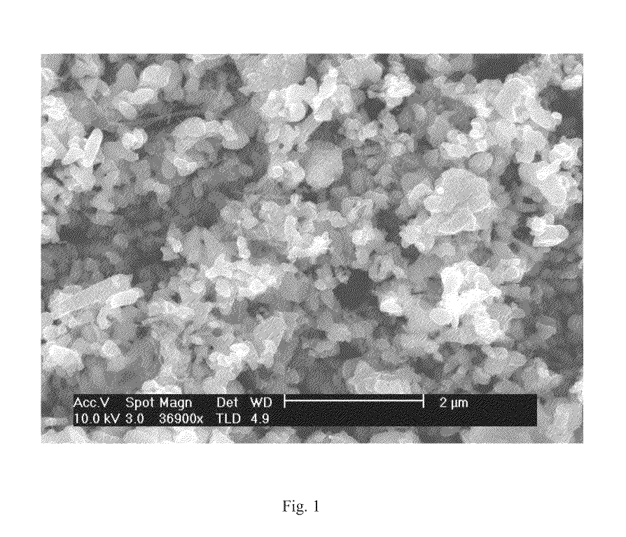

The SEM image of lithium iron phosphate prepared in the example is shown as FIG. 1, it can be seen from FIG. 1 that the particle size of lithium iron phosphate is tiny and uniform.

Preparing the lithium ion battery using the lithium iron phosphate cathode material prepared in the example. Taking electrochemical charge-discharge test for the lithium ion battery under the current density of 1C and 35C. The energy density of the lithium ion battery is 300 wh/kg, 180 wh/kg, respectively, under the current density of 1C and 35C. Taking cycling life test for the lithium ion battery under the current density of 1C, after 15(X) cycles, the energy density of the lithium ion battery can remain more than 90%.

### Example 2

Mixing 35.15 g of lithium carbonate (formula is Li₂CO₃, 0.475 mol), 404 g of ferric nitrate (formula is Fe(NO₃)₃.9H₂O, 1 mol). 115 g of ammonium dihydrogen phosphate (formula is NH₄H₂PO₄, 1 mol), 18.75 g of aluminum nitrate (formula is Al(NO₃)₃.9H₂O, 0.05 mol), then mixing with 573 g of oxalic acid and dissolving in the isopropanol to obtain mixture A. Adding 79.5 g of ethylene glycol into the mixture A, the accelerant ethylene glycol makes the mixture A achieve chemical reaction to release heat, as to the moisture in the reaction solution is dehydrated by the heat naturally, and obtaining a solid precursor of lithium iron phosphate. Drying the obtained precursor at 100° C. for 20 hours, and sintering in the nitrogen atmosphere furnace at 700° C. for 10 hours, then obtaining the lithium iron phosphate material.

Preparing the lithium ion battery using the lithium iron phosphate cathode material prepared in the example. Taking electrochemical charge-discharge test for the lithium ion battery under the current density of 1C and 35C. Under the current density of 1C and 35C, the energy density of the lithium ion battery is 280 wh/kg, 176 wh/kg, respectively. Taking cycling life test for the lithium ion battery under the current density of 1C, after 1500 cycles, the energy density of the lithium ion battery can remain more than 90%.

### Example 3

Mixing 35.15 g of lithium carbonate (formula is Li₂CO₃, 0.475 mol). 404 g of ferric nitrate (formula is Fe(NO₃)₃.9H₂O, 1 mol), 115 g of ammonium dihydrogen phosphate (formula is NH₄H₂PO₄, 1 mol), 18.75 g of aluminum nitrate (formula is Al(NO₃)₃.9H₂O, 0.05 mol), then mixing with 5.73 kg of salicylic acid and dissolving in the water to obtain mixture A. Adding 143.1 g of ethyl formate into the mixture A, the accelerant ethyl formate makes the mixture A achieve chemical reaction to release heat, as to the moisture in the reaction solution is dehydrated by the heat naturally, and obtaining a solid precursor of lithium iron phosphate. Drying the obtained precursor at 120° C. for 16 hours, and sintering in the argon atmosphere furnace at 900° C. for 5 hours, then obtaining the lithium iron phosphate material.

Preparing the lithium ion battery using the lithium iron phosphate cathode material prepared in the example. Taking electrochemical charge-discharge test for the lithium ion battery under the current density of 1C and 35C. Under the current density of 1C and 35C, energy density of the lithium ion battery is 275 wh/kg, 170 wh/kg, respectively. Taking cycling life test for the lithium ion battery under the current density of 1C, after 1500 cycles, the energy density of the lithium ion battery can remain more than 90%.

### Example 4

Mixing 69 g of lithium nitrate (formula is Li NO₃, 1 mol), 179.9 g of ferrous oxalate (formula is FeC₂O₄.2H₂O, 1 mol), 125.4 g of diammonium hydrogen phosphate (formula is (NH₄)₂HPO₄, 0.95 mol), 1.74 g of boron oxide (formula is B₂O₃, 0.025 mol), then mixing with 752 g of tartaric acid and dissolving in the propanol to obtain mixture A. Mixing 1.25 g of multi-walled carbon nanotubes and 12.5 g of polyethylene glycol and disperse in propanol by ultrasonic, to form conductive carbon dispersion B. Mixing the mixture A and the conductive carbon dispersion B, and obtaining mixture A containing conductive carbon dispersion B. Adding 24.9 g of acetaldehyde into the mixture A containing conductive carbon dispersion B, the accelerant added makes the mixture A achieve chemical reaction to release heat, as to the moisture in the reaction solution is dehydrated by the heat naturally, and obtaining a solid precursor of lithium iron phosphate. Drying the obtained precursor at 150° C. for 12 hours, and sintering in the nitrogen atmosphere furnace at 500° C. for 16 hours, then obtaining the lithium iron phosphate material.

Preparing the lithium ion battery using the lithium iron phosphate cathode material prepared in the example. Taking electrochemical charge-discharge test for the lithium ion battery under the current density of 1C and 35C. Under the current density of 1C and 35C, energy density of the lithium ion battery is 295 wh/kg, 179 wh/kg, respectively. Taking cycling life test for the lithium ion battery under the current density of 1C, after 1500 cycles, the energy density of the lithium ion battery can remain more than 90%.

### Example 5

Mixing 69 g of lithium nitrate (formula is LiNO₃, 1 mol), 179.9 g of ferrous oxalate (formula is FeC₂O₄.2H₂O, 1 mol), 125.4 g of diammonium hydrogen phosphate (formula is (NH₄)₂HPO₄, 0.95 mol). 1.74 g of boron oxide (formula is B₂O₃, 0.025 mol), then mixing with 37.6 g of succinic acid and dissolving in the propanol to obtain mixture A. Mixing 6.2 g of acetylene black and 31 g of sodium polystyrene sulfonate and disperse in propanol by ultrasonic, to form conductive carbon dispersion B. Mixing the mixture A and the conductive carbon dispersion B, and obtaining mixture A containing conductive carbon dispersion B. Adding 62.1 g of peroxyacetic acid into the mixture A containing conductive carbon dispersion B, the accelerant peroxyacetic acid makes the mixture A achieve chemical reaction to release heat, as to the moisture in the reaction solution is dehydrated by the heat naturally, and obtaining a solid precursor of lithium iron phosphate. Drying the obtained precursor at 18° C. for 10 hours, and sintering in the argon atmosphere furnace at 700° C. for 10 hours, then obtaining the lithium iron phosphate material.

Preparing the lithium ion battery using the lithium iron phosphate cathode material prepared in the example. Taking electrochemical charge-discharge test for the lithium ion battery under the current density of 1C and 35C. Under the current density of 1C and 35C, energy density of the lithium ion battery is 287 wh/kg, 173 wh/kg, respectively. Taking cycling life test for the lithium ion battery under the current density of 1C, after 1500 cycles, the energy density of the lithium ion battery can remain more than 90%.

### Example 6

Mixing 69 g of lithium nitrate (formula is LiNO₃, 1 mol), 179.9 g of ferrous oxalate (formula is FeC₂O₄.2H₂O, 1 mol), 125.4 g of dianunonium hydrogen phosphate (formula is (NH₄₂HPO₄, 0.95 mol). 1.74 g of boron oxide (formula is B₂O₃, 0.025 mol), then mixing with 1.88 kg of sucrose and dissolving in the propanol to obtain mixture A. Mixing 10 g of multi-walled carbon nanotubes and 0.1 g of polyoxyethylene and disperse in propanol by ultrasonic, to form conductive carbon dispersion B. Mixing the mixture A and the conductive carbon dispersion B, and obtaining mixture A containing conductive carbon dispersion B. Adding 55.9 g of acetaldehyde and 55.9 g formic acid into the mixture A containing conductive carbon dispersion B, the acetaldehyde and formic acid make the mixture A achieve chemical reaction to release heat, as to the moisture in the reaction solution is dehydrated by the heat naturally, and obtaining a solid precursor of lithium iron phosphate. Drying the obtained precursor at 100° C. for 20 hours, and sintering in the nitrogen atmosphere furnace at 900° C. for 5 hours, then obtaining the lithium iron phosphate material.

Preparing the lithium ion battery using the lithium iron phosphate cathode material prepared in the example. Taking electrochemical charge-discharge test for the lithium ion battery under the current density of 1C and 35C. Under the current density of 1C and 35C, energy density of the lithium ion battery is 267 wh/kg, 168 wh/kg, respectively. Taking cycling life test for the lithium ion battery under the current density of 1C, after 1500 cycles, the energy density of the lithium ion battery can remian more than 90%.

### Example 7

Compared to example 6, in example 7, the distinction is only that the accelerant added into mixture A is different. The accelerants include 37.3 g of acetaldehyde and 37.3 g ethyl formate in this example.

### Example 8

Compared to example 6, in example 8, the distinction is only that the accelerant added into mixture A is different. The accelerants include 49.7 g of ethylene glycol and 49.7 g ethyl formate in this example.

### Example 9

Mixing 35.15 g of lithium carbonate (formula is Li₂CO₃, 0.475 mol). 87 g of manganese dioxide (formula is MnO₂, 1 mol), 115 g of ammonium dihydrogen phosphate (formula is NH₄H₂PO₄, 1 mol), 18.75 g of aluminum nitrate (formula is Al(NO₃)₃.9H₂O, 0.05 mol), then mixing with 25.6 g of malic acid and dissolving in the water to obtain mixture A. Mixing 8 g of single-walled carbon nanotubes and 4 g of polyvinyl alcohol and disperse in water by ultrasonic, to form conductive carbon dispersion B. Mixing the mixture A and the conductive carbon dispersion B, and obtaining mixture A containing conductive carbon dispersion B. Adding 15.8 g of formic acid into the mixture A containing conductive carbon dispersion B, the accelerant formic acid makes the mixture A achieve chemical reaction to release heat, as to the moisture in the reaction solution is dehydrated by the heat naturally, and obtaining a solid precursor of lithium manganese phosphate. Drying the obtained precursor at 80° C. for 24 hours, and sintering in the nitrogen atmosphere furnace at 500° C. for 16 hours, then obtaining the lithium manganese phosphate material.

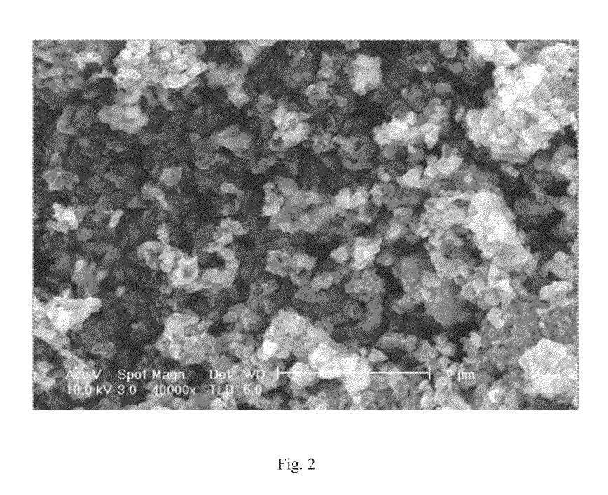

The SEM image of lithium manganese phosphate prepared in the example is shown as FIG. 2, it can be seen from FIG. 2 that the particle size of lithium manganese phosphate prepared in the example is tiny and uniform, carbon nanotubes dispersed in the material.

Preparing the lithium ion battery using the lithium manganese phosphate cathode material prepared in the example. Taking electrochemical charge-discharge test for the lithium ion battery under the current density of 1C and 5C, under the current density of 1C and 5C, the energy density of the lithium ion battery is 297 wh/kg, 233 wh/kg, respectively. Taking cycling life test for the lithium ion battery under the current density of 1C, after 1000 cycles, the energy density of the lithium ion battery can remain more than 90%.

### Example 10

Compared to example 9, in example 10, the distinction is only that the accelerant added into mixture A is different. The accelerant is 79 g of ethylene glycol in this example.

### Example 11

Compared to example 9, in example 11, the distinction is only that the accelerant added into mixture A is different. The accelerants include 39.5 g of acetaldehyde and 39.5 g formic acid in this example.

### Example 12

Compared to example 9, in example 12, the distinction is only that the accelerant added into mixture A is different. The accelerant is 39.5 g of peracetic acid in this example.

### Example 13

### Compared to example 9, in example 13, the distinction is only that the accelerant added into mixture A is different. The accelerant is 142.2 g of ethyl formate in this example.

### Example 14

Compared to example 9, in example 14, the distinction is only that the accelerant added into mixture A is different. The accelerants include 47.4 g formic acid, 47.4 g of acetaldehyde and 47.4 g of ethyl formate in this example.

### Example 15

Mixing 22.8 g of lithium hydroxide (formula is LiOH, 0.95 mol), 104.4 g of ferrous carbonate (formula is FeCO₃, 0.9 mol). 8.7 g of manganese dioxide (formula is MnO₂, 0.1 mol), 98 g of phosphoric acid (formula is H₃PO₄,1 mol), 12.08 g of copper nitrate (formula is Cu(NO₃)₂.3H₂O, 0.05 mol), then mixing with 24.6 g of citric acid and dissolving in the water to obtain mixture A. Mixing 8 g of single-walled carbon nanotubes and 8 g of polyvinyl alcohol and disperse in water by ultrasonic, to form conductive carbon dispersion B. Mixing the mixture A and the conductive carbon dispersion B, and obtaining mixture A containing conductive carbon dispersion B. Adding 16.1 g of formic acid into the mixture A containing conductive carbon dispersion B, the accelerant formic acid makes the mixture A achieve chemical reaction to release heat, as to the moisture in the reaction solution is dehydrated by the heat naturally, and obtaining a solid precursor of lithium ferric manganese phosphate. Drying the obtained precursor at 80° C. for 24 hours, and sintering in the nitrogen atmosphere furnace at 500° C. for 16 hours, then obtaining the lithium ferric manganese phosphate material.

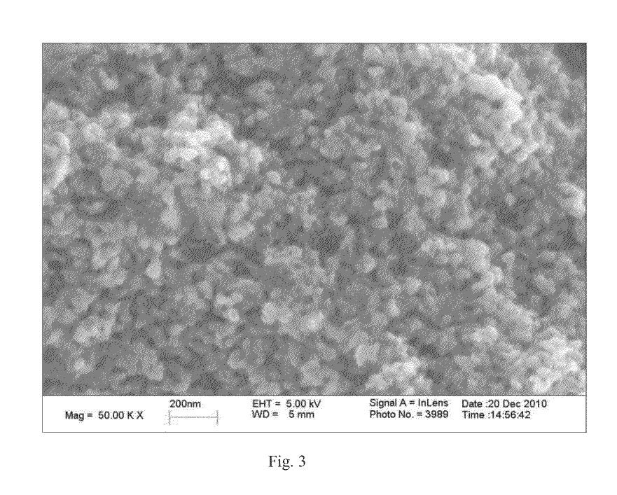

The SEM image of lithium ferric manganese phosphate prepared in the example is shown as FIG. 3, it can be seen from FIG. 3 that the particle size of lithium ferric manganese phosphate prepared in the example is tiny and uniform, carbon nanotubes dispersed in the material.

Preparing the lithium ion battery using the lithium ferric manganese phosphate cathode material prepared in the example. Taking electrochemical charge-discharge test for the lithium ion battery under the current density of 1C and 5C, under the current density of 1C and 5C, the energy density of the lithium ion battery is 326 wh/kg, 280 wh/kg, respectively. Taking cycling life test for the lithium ion battery under the current density of 1C, after 1000 cycles, the energy density of the lithium ion battery can remain more than 90%.

### Example 16

Compared to example 15, in example 16, the distinction is only that the accelerant added into mixture A is different. The accelerant is 32.2 g of ethylene glycol in this example.

### Example 17

Compared to example 15, in example 17, the distinction is only that the accelerant added into mixture A is different. The accelerants include 32.2 g of acetaldehyde and 32.2 g formic acid.

### Example 18

Compared to example 15, in example 18, the distinction is only that the accelerant added into mixture A is different. The accelerant is 80.4 g of peroxyacetic acid in this example.

### Example 19

Compared to example 15, in example 19, the distinction is only that the accelerant added into mixture A is different. The accelerant is 96.5 g of ethyl formate in this example.

### Example 20

Compared to example 15, in example 20, the distinction is only that the accelerant added into mixture A is different. The accelerants include 48.2 g formic acid. 48.2 g of acetaldehyde and 48.2 g of ethyl formate in this example.

What is claimed is:

1. An auto-thermal evaporative liquid-phase synthesis method for cathode material for battery, comprising the following steps:
(1) Adding synthetic raw materials of cathode material into a solvent to obtain a mixture A, the synthetic raw materials of cathode material contain lithium source, adding an accelerant into the mixture A, which makes the mixture A achieve a strong auto-thermal reaction to release heat to evaporate the solvent naturally, and obtaining a solid precursor of the cathode material;
(2) Drying the precursor of the cathode material, sintering in an atmosphere furnace and obtaining the cathode material.

2. The auto-thermal evaporative liquid-phase synthesis method for cathode material for battery according to claim 1, in the step (1), said accelerant is one of or any their combination of reducing alcohol, reducing organic compounds containing aldehyde group and organic peracid.

3. The auto-thermal evaporative liquid-phase synthesis method for cathode material for battery according to claim 2, in the step (1), said accelerant is one of or any their combination of ethylene glycol, formic acid, ethyl formate, glucose, acetaldehyde, formaldehyde and peroxyacetic acid.

4. The auto-thermal evaporative liquid-phase synthesis method for cathode material for battery according to claim 1, in the step (1), the amount of said accelerant is 10-90% of the mass of cathode material.

5. The auto-thermal evaporative liquid-phase synthesis method for cathode material for battery according to claim 1, in the step (2), sintering temperature is in the range of 500-900° C., and sintering time is in the range of 3-16 hours.

6. The auto-thermal evaporative liquid-phase synthesis method for cathode material for battery according to claim 1, wherein, in the step (1), before adding said accelerant, adding conductive carton dispersion liquid B dispersed by additive into said mixture A, said conductive carbon is one or more of carbon nanotube, conductive carbon black and acetylene black, the weight percentage of said conductive carbon in the cathode material is 0.1-10%.

7. The auto-thermal evaporative liquid-phase synthesis method for cathode material for battery according to claim 6, wherein, said additive is one or more of polyvinyl alcohol, polyethylene glycol, polyethylene oxide, sodium polystyrene sulfonate, polyoxyethylene nonylphenyl ether, cetyl trimethyl ammonium chloride, cetyl trimethyl ammonium bromide, octadecyl trimethyl ammonium chloride and octadecyl trimethyl ammonium bromide, said conductive carbon mix with said additive in terms of the weight ratio of 1:0.01-10 and disperse in said solvent by ultrasonic.

8. The auto-thermal evaporative liquid-phase synthesis method for cathode material for battery according to claim 1, wherein, in the step (1), said lithium source comprising one or more of lithium dihydrogen phosphate, lithium hydroxide, lithium carbonate, lithium nitrate and lithium chloride; said solvent is one or more of water, methanol, ethanol, propanol, isopropanol, n-butyl alcohol, isobutyl alcohol, n-amyl alcohol, hexyl alcohol, heptanol, acetone, butanone, butanedione, pentanone, cyclopentanone, hexanone, cyclohexanone and cycloheptanone.

9. The auto-thermal evaporative liquid-phase synthesis method for cathode material for battery according to claim 1, wherein, said cathode material is lithium cobalt oxide, lithium nickel oxide, lithium manganese oxide, lithium ferrous metasilicate, lithium manganese phosphate, lithium ferric manganese phosphate or lithium iron phosphate.

10. The auto-thermal evaporative liquid-phase synthesis method for cathode material for battery according to claim 1, wherein, said synthetic raw materials of the cathode material are soluble lithium source, iron source, phosphorus source, doping elements source and complexing agent; said iron source including one or more of iron phosphate, ferric nitrate, ferrous oxalate, ferric oxide, ferric sulfate and ferrous sulfate; said phosphorus source including one or more of phosphoric acid, ammonium hydrogen phosphate, ammonium dihydrogen phosphate, iron phosphate and lithium dihydrogen phosphate; said doping elements source is one or more of their compounds of boron, cadmium, copper, magnesium, aluminum, zinc, manganese, titanium, zirconium, niobium, chromium and rare earth compounds, said complexing agent is one or more of citric acid, malic acid, tartaric acid, oxalic acid, salicylic acid, succinic acid, glycine, EDTA and sucrose.

11. The auto-thermal evaporative liquid-phase synthesis method for cathode material for battery according to claim 1, said mixture A prepared by the following method: mixing the soluble lithium source, iron source, phosphorus source and doping elements source in molar ratio, then mixing with complexing agent in terms of the weight ratio of 1:0.1-10 and dissolving in the solvent to form the mixture A.

12. The auto-thermal evaporative liquid-phase synthesis method for cathode material for battery according to claim 11, in said mixture A, said lithium source, iron source, phosphorus source and doping elements source were mixed in terms of the molar ratio of Li:Fe:P: doping element that 0.95-1:0.95-1:0.95-1:0-0.05.
